(19) United States
(12) Patent Application Publication
(10) Pub. No.: US 2026/0358757 A1
(43) Pub. Date: Nov. 12, 2026

(54) MULTI-DEPTH DIFFRACTION FIELD COMPUTING METHOD BASED ON PHASE INITIALIZATION, DEVICE, AND MEDIUM

(71) Applicant: Army Academy of Armored Forces, Beijing (CN)

(72) Inventors: Xingpeng YAN, Beijing (CN); Jiaqi LI, Beijing (CN); Yanan ZHANG, Beijing (CN); Yang YU, Beijing (CN); Hairong HU, Beijing (CN); Hebin CHANG, Beijing (CN); Congcong ZHANG, Beijing (CN)

(21) Appl. No.: 19/278,095

(22) Filed: Jul. 23, 2025

(30) Foreign Application Priority Data
May 6, 2025 (CN) 202510578225.3

(51) Int. Cl. G03H 1/08

(52) U.S. Cl. CPC G03H 1/0808; G03H 2001/0825

(57) ABSTRACT

Provided are a multi-depth diffraction field computing method based on phase initialization, a device, and a medium, relating to the field of computer data processing. The method includes performing integer multiple processing on an initial diffraction interval and an initial depth interval based on a laser wavelength to achieve initialization, thereby obtaining an optimized diffraction interval and an optimized depth interval; performing diffraction simulation based on the optimized diffraction interval, the laser wavelength, and the optimized depth interval, determining an optical transfer function based on the optimized depth interval, and then reusing optical transfer function to determine a multi-depth diffraction field. This application can rapidly and accurately determine the multi-depth diffraction field and provide the data basis for subsequent 3D scene reconstruction.

### CROSS REFERENCE TO RELATED APPLICATION

This patent application claims the benefit and priority of Chinese Patent Application No. 202510578225.3, filed with the China National Intellectual Property Administration on May 6, 2025, the disclosure of which is incorporated by reference herein in its entirety as part of the present application.

### TECHNICAL FIELD

The present disclosure relates to the field of computer data processing, and in particular, to a multi-depth diffraction field computing method based on phase initialization, a device, and a medium.

### BACKGROUND

Computer-Generated Holograms (CGHs) are generated by calculating and simulating the propagation of light waves from an object. In computer-generated holography, traditional phase initialization methods either suffer from high computational complexity or poor reconstruction quality, making it difficult to meet the requirements for real-time 3D display. For example, random phase initialization may introduce speckle noise and reduce reconstruction quality; in constant phase initialization, to ensure positional and phase consistency, an optical transfer function (OTF) needs to be computed multiple times within a 3D scene. However, as the computation speed is related to the number of layers, the process becomes slow.

### SUMMARY

An objective of the present disclosure is to provide a multi-depth diffraction field computing method based on phase initialization, a device, and a medium, which can rapidly and accurately determine multi-depth diffraction fields and provide the data basis for subsequent 3D scene reconstruction.

To achieve the above objective, the present disclosure provides the following technical solutions:

According to a first aspect, a multi-depth diffraction field computing method based on phase initialization, including:
obtaining an initial diffraction interval, a laser wavelength, and an initial depth interval;
performing integer multiple processing on the initial diffraction interval and the initial depth interval based on the laser wavelength to achieve initialization, thereby obtaining an optimized diffraction interval and an optimized depth interval; and
performing diffraction simulation based on the optimized diffraction interval, the laser wavelength, and the optimized depth interval, determining an optical transfer function according to the optimized depth interval, and then reusing the optical transfer function to determine a multi-depth diffraction field.

According to a second aspect, the present disclosure provides a computer device, including: a memory, a processor, and a computer program stored in the memory and executable on the processor, where the processor executes the computer program to implement the multi-depth diffraction field computing method based on phase initialization.

According to a third aspect, the present disclosure provides a computer readable storage medium storing a computer program, where the computer program implements the multi-depth diffraction field computing method based on phase initialization when being executed by a processor.

According to a fourth aspect, the present disclosure provides a computer program product, including a computer program, where the computer program implements the multi-depth diffraction field computing method based on phase initialization when being executed by a processor.

According to the embodiments of the present disclosure, the present disclosure achieves the following technical effects: The present disclosure provides a multi-depth diffraction field computing method based on phase initialization, a device, and a medium. By performing integer multiple processing on the initial diffraction interval and the initial depth interval based on the laser wavelength, it is possible to ensure that, during the diffraction simulation process in computer-generated holography, a uniform optical transfer function is generated. That is, for different depth layers at the same wavelength obtained from the diffraction simulation, since the corresponding depth intervals are the same, the optical transfer function for information transmission between different depth layers is identical. In the determination of the multi-depth diffraction field, the aforementioned optical transfer function can be directly reused without the need to compute a corresponding optical transfer function for each depth layer, thereby avoiding repetitive computation of the optical transfer function, significantly reducing the computational load and avoid introducing speckle noise. This method enables rapid and accurate determination of the multi-depth diffraction field, providing a data basis for subsequent 3D scene reconstruction.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 illustrates an application environment of a multi-depth diffraction field computing method based on phase initialization according to an embodiment of the present disclosure;

FIG. 2 is a schematic flowchart of a multi-depth diffraction field computing method based on phase initialization according to an embodiment of the present disclosure;

FIG. 3 is a schematic diagram of integer multiple processing according to an embodiment of the present disclosure; and

FIG. 4 is a schematic structural diagram of a computer device according to an embodiment of the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

The present disclosure proposes an efficient and consistent phase initialization method by optimizing the relationship between the laser wavelength and the diffraction interval as well as the depth interval, solving the problem of low computational efficiency and data inconsistency in the prior art.

To make the above objectives, features, and advantages of the present disclosure more obvious and easy to understand, the present disclosure will be further described in detail with reference to the accompanying drawings and specific implementations.

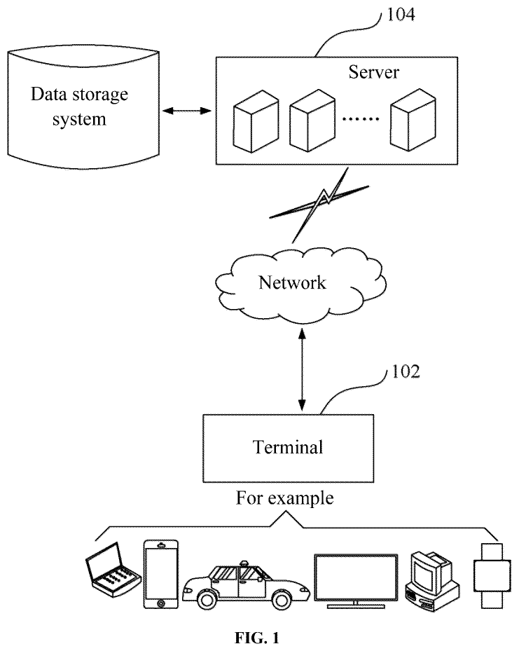

The multi-depth diffraction field computing method based on phase initialization provided in the embodiments of the present disclosure can be applied to the application environment as shown in FIG. 1. A terminal 102 communicates with a server 104 via a network. A data storage system can store data that the server 104 needs to process. The data storage system can be independently set up, integrated with the server 104, or placed in the cloud or on other servers. The terminal 102 can send an initial diffraction interval, a laser wavelength, and an initial depth interval to the server 104. Upon receiving this information, the server 104 performs integer multiple processing on the initial diffraction interval and initial depth interval based on the laser wavelength to achieve initialization, thereby obtaining an optimized diffraction interval and an optimized depth interval. Subsequently, diffraction simulation is performed. In this process, an optical transfer function is determined based on the optimized depth interval, and the optical transfer function is then reused to determine a multi-depth diffraction field. On this foundation, the server 104 can further utilize neural networks to reconstruct a 3D scene and feed the reconstructed 3D scene back to the terminal 102. Additionally, in some embodiments, the multi-depth diffraction field computing method based on phase initialization may also be implemented solely by the server 104 or the terminal 102.

The second terminal 102 may be, but is not limited to, various devices such as desktop computers, laptops, smartphones, and tablets. The server 104 can be implemented using a standalone server, a server cluster consisting of a plurality of servers, or a cloud server.

The process of computer-generated holography includes: representing a target object within a computer using shape data or mathematical formulas; based on a preset laser source and optical properties of the target object, calculating a complex amplitude distribution of light waves emitted or reflected by the target object on an object plane, where the complex amplitude contains amplitude and phase information of the light wave; performing angular spectrum propagation calculations, Fourier transforms, and others based on the complex amplitude, to produce a 2D hologram containing information of a 3D scene where the target object resides; and processing the 2D hologram, to reconstruct the 3D scene of the target object.

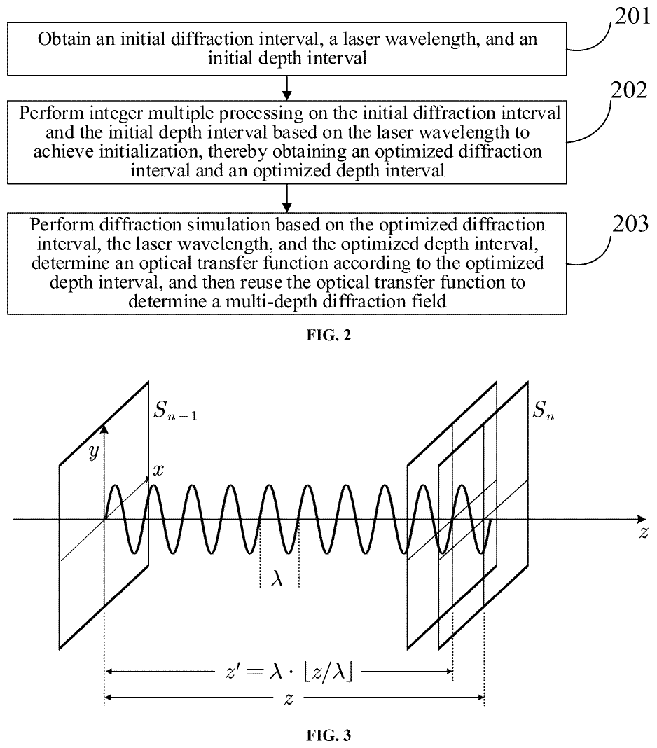

In an exemplary embodiment, as shown in FIG. 2, a multi-depth diffraction field computing method based on phase initialization is provided, which is executed by a computer device. Specifically, the method can be executed solely by a computer device such as a terminal or a server, or jointly by a terminal and a server. In the embodiments of the present disclosure, the method being applied on the server 104 in FIG. 1 is taken as an example for description, including step 201 to step 203 as follows:
Step 201: Obtain an initial diffraction interval, a laser wavelength, and an initial depth interval. The initial diffraction interval and initial depth interval can be set by skilled personnel based on experience or calculated as needed.
Step 202: Perform integer multiple processing on the initial diffraction interval and the initial depth interval based on the laser wavelength to achieve initialization, thereby obtaining an optimized diffraction interval and an optimized depth interval.

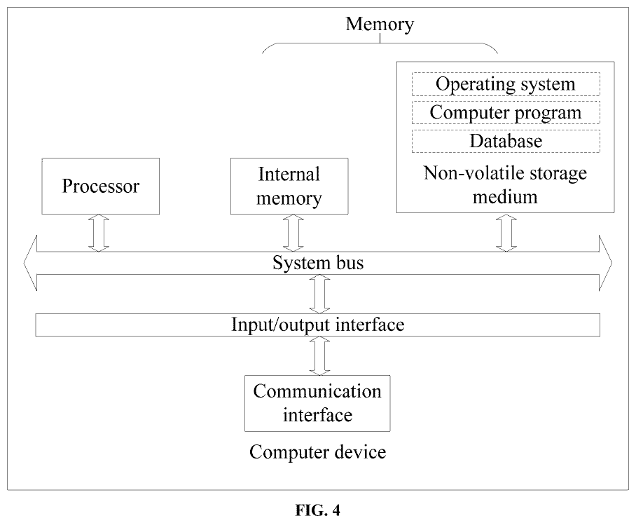

As shown in FIG. 3, the step of performing integer multiple processing on the initial diffraction interval based on the laser wavelength to achieve data initialization, thereby obtaining the optimized diffraction interval includes:

The optimized diffraction interval is calculated using the following formula: z′=λ·└z/λ┘, where z represents the initial diffraction interval, λ represents the laser wavelength, └·┘ represents a round-down function, and z′ represents the optimized diffraction interval.

The integer multiple processing for the initial depth interval follows the same process as that for the initial diffraction interval and will not be elaborated further here.
Step 203: Perform diffraction simulation based on the optimized diffraction interval, the laser wavelength, and the optimized depth interval, determine an optical transfer function according to the optimized depth interval, and then reuse the optical transfer function to determine a multi-depth diffraction field.

The optical transfer function is as follows: H_{Δz′}(fₓ,f_{y})=exp[jkΔz′\sqrt{1−(λfₓ)²−(λf_{y})²}], where H_{Δz′}(fₓ,f_{y}) represents the optical transfer function, and j represents an imaginary unit; k=2π/λ, with k representing the number of waves, and λ representing the laser wavelength; Δz′ represents the optimized depth interval; fₓ and f_{y} represent frequency domain coordinates; |fₓ|, |f_{y}|<½Δp, with Δp representing a pixel interval of a spatial light modulator used during the diffraction simulation.

By adjusting the diffraction interval and depth interval to integer multiples of the laser wavelength, a uniform optical transfer function is generated during the diffraction simulation process. The optical transfer function can be reused, eliminating repetitive calculations, reducing computational load, and significantly improving computational efficiency.

An iterative process of multi-depth diffraction can be extended to more general scenarios without sacrificing generality. Assuming that a target scene is evenly divided into N depth layers, with an optimized depth interval of Δz′, the process of determining the multi-depth diffraction field involves the following steps:
(1) For a depth layer in the diffraction simulation, calculate a complex amplitude according to the optical transfer function by using an angular spectrum method, to describe a diffraction field of the depth layer, where a formula for calculating the complex amplitude of the depth layer is as follows:

ASM{Uₙ(x,y)}_{Δz′}=F⁻¹{F{Uₙ(x,y)}·H_{Δz′}(fₓ,f_{y})};

Uₙ(x,y)=Λ{Uₙ₋₁(x,y)}_{Δz′}=\sqrt{I(x,y)}·exp[jφ₀]·Mₙ(x,y)+ASM{Uₙ₋₁(x,y)}_{Δx′}·[1−Mₙ(x,y)];

where ASM{·}_{Δz′} represents a calculation formula of the angular spectrum method for diffraction, Δz′ represents the optimized depth interval, and Uₙ(x, y) represents a complex amplitude of an n-th depth layer; F{·} represents a Fourier transform function, F⁻¹{·} represents an inverse Fourier transform function, and H_{Δz′}(fₓ,f_{y}) represents the optical transfer function; Λ{·} represents angular spectrum diffraction processing, and Uₙ₋₁(x, y) represents a complex amplitude of an (n−1)-th depth layer; \sqrt{I(x,y)} represents an amplitude of an intensity image; j represents an imaginary unit, satisfying j²=−1; φ₀ represents a constant phase term; Mₙ(x,y) represents a Boolean mask corresponding to the n-th depth layer Sₙ, where n∈[0, N−1], n is an integer, and N is a total number of depth layers in the diffraction simulation.
(2) Iteratively calculate a complex amplitude of a next depth layer according to the complex amplitude of the depth layer, to ultimately obtain a complex amplitude of a hologram plane for describing the multi-depth diffraction field. A formula for calculating the complex amplitude of the hologram plane is as follows:

Uₕ(x,y)=ASM{U_{N-1}(x,y)}_{-z}_{ₕ}_{′-(N-1)Δz′};

where Uₕ(x,y) represents the complex amplitude of the hologram plane Sₕ, (−zₕ′−(N−1)Δz′) represents a backward distance from an (N−1)-th depth layer to the hologram plane Sₕ, zₕ represents a distance from the first depth layer to the hologram plane Sₕ, and zₕ′ represents a distance after zₕ is optimized.

After the multi-depth diffraction field is determined, the complex amplitude Uₕ(x,y) of the hologram plane is used for encoding the multi-depth hologram via neural networks. The phase initialization method described in the present disclosure to compute the multi-depth diffraction field can also be named position-period-dependent phase initialization method (PPD-PIM), which significantly accelerates the generation of multi-depth holograms.

In summary, for scenarios involving different depth layers under the same wavelength, the method of the present disclosure reuses a unified optical transfer function, thereby accelerating the calculation of diffraction fields across each depth layer using fast Fourier transform. The strict integer-multiple adjustments based on the wavelength ensure sufficient accuracy for human visual requirements while maximizing the reuse rate of the optical transfer function. This approach achieves fast computation of multi-depth diffraction fields, simultaneously ensuring the quality of holographic reconstruction while significantly improving hologram generation efficiency. The unified optical transfer function guarantees statistical consistency of diffraction fields across different depth layers, thereby enhancing the effectiveness of machine learning model training in the subsequent 3D scene reconstruction step. Additionally, the method of the present disclosure is compatible with holographic display devices based on the angular spectrum method (for example, spatial light modulator (SLM)) and does not require any additional hardware modifications.

In an embodiment, a computer device is provided. The computer device may be a server or a terminal, and an internal structure thereof may be as shown in FIG. 4. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The I/O interface of the computer device is configured to exchange information between the processor and an external device. The communication interface of the computer device is configured to communicate with an external terminal through a network. The computer program implements the multi-depth diffraction field computing method based on phase initialization when being executed by the processor.

Those skilled in the art may understand that the structure shown in FIG. 4 is only a block diagram of a part of the structure related to the solutions of the present disclosure and does not constitute a limitation on a computer device to which the solutions of the present disclosure are applied. Specifically, the computer device may include more or fewer components than those shown in the figure, or combine some components, or have different component arrangements. In an embodiment, a computer device is provided, including a memory, a processor, and a computer program stored in the memory and executable on the processor. The processor executes the computer program to implement the steps in the above method embodiments.

In an embodiment, a computer-readable storage medium is provided, storing a computer program, where the computer program implements the steps in the above method embodiments when being executed by the processor.

In an embodiment, a computer program product is provided. The computer program product includes a computer program, and the computer program implements the steps in the above method embodiment when being executed by a processor.

It is to be noted that information of a user (including but not limited to device information of the user, personal information of the user and the like) and data (including but not limited to data for analysis, data for storage, data for exhibition and the like) in the present disclosure are information and data authorized by the user or fully authorized by each party, and relevant data shall be acquired, used and processed according to related regulations.

Those of ordinary skill in the art may understand that all or some of the procedures in the method of the foregoing embodiments may be implemented by a computer program instructing related hardware. The computer program may be stored in a non-volatile computer-readable storage medium. When the computer program is executed, the procedures in the embodiments of the foregoing method may be performed. Any reference to a memory, a storage, a database, or other media used in the embodiments of the present disclosure may include a non-volatile and/or volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical features of the above embodiments can be employed in arbitrary combinations. To provide a concise description of these embodiments, all possible combinations of all the technical features of the above embodiments may not be described; however, these combinations of the technical features should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A multi-depth diffraction field computing method based on phase initialization, comprising:
obtaining an initial diffraction interval, a laser wavelength, and an initial depth interval;
performing integer multiple processing on the initial diffraction interval and the initial depth interval based on the laser wavelength to achieve initialization, thereby obtaining an optimized diffraction interval and an optimized depth interval; and
performing diffraction simulation based on the optimized diffraction interval, the laser wavelength, and the optimized depth interval, determining an optical transfer function according to the optimized depth interval, and then reusing the optical transfer function to determine a multi-depth diffraction field.

2. The multi-depth diffraction field computing method based on phase initialization according to claim 1, wherein the performing integer multiple processing on the initial diffraction interval based on the laser wavelength to achieve initialization, thereby obtaining the optimized diffraction interval comprises:
calculating the optimized diffraction interval using the following formula: z′=λ·└z/λ┘, wherein z represents the initial diffraction interval, λ represents the laser wavelength, └·┘ represents a round-down function, and z′ represents the optimized diffraction interval.

3. A computer device, comprising a memory, a processor, and a computer program stored in the memory and executable on the processor, wherein the processor executes the computer program to implement the multi-depth diffraction field computing method based on phase initialization according to claim 2.

4. A non-transitory computer-readable storage medium storing a computer program, wherein the computer program, when executed by a processor, implements the multi-depth diffraction field computing method based on phase initialization according to claim 2.

5. The multi-depth diffraction field computing method based on phase initialization according to claim 1, wherein the optical transfer function is as follows: H_{Δz′}(fₓ,f_{y})=exp[jkΔz′\sqrt{1−(λfₓ)²−(λf_{y})²}], wherein H_{Δz′}(fₓ,f_{y}) represents the optical transfer function, and j represents an imaginary unit; k=2π/λ, with k representing a number of waves, and λ representing the laser wavelength; Δz′ represents the optimized depth interval; and fₓ and f_{y} represent frequency domain coordinates.

6. A computer device, comprising a memory, a processor, and a computer program stored in the memory and executable on the processor, wherein the processor executes the computer program to implement the multi-depth diffraction field computing method based on phase initialization according to claim 5.

7. A non-transitory computer-readable storage medium storing a computer program, wherein the computer program, when executed by a processor, implements the multi-depth diffraction field computing method based on phase initialization according to claim 5.

8. The multi-depth diffraction field computing method based on phase initialization according to claim 1, wherein the determining the multi-depth diffraction field comprises:
for a depth layer in the diffraction simulation, calculating a complex amplitude according to the optical transfer function by using an angular spectrum method, to describe a diffraction field of the depth layer; and
iteratively calculating a complex amplitude of a next depth layer according to the complex amplitude of the depth layer, to ultimately obtain a complex amplitude of a hologram plane for describing the multi-depth diffraction field.

9. A computer device, comprising a memory, a processor, and a computer program stored in the memory and executable on the processor, wherein the processor executes the computer program to implement the multi-depth diffraction field computing method based on phase initialization according to claim 8.

10. A non-transitory computer-readable storage medium storing a computer program, wherein the computer program, when executed by a processor, implements the multi-depth diffraction field computing method based on phase initialization according to claim 8.

11. The multi-depth diffraction field computing method based on phase initialization according to claim 8, wherein a formula for calculating the complex amplitude of the depth layer is as follows:
ASM{Uₙ(x,y)}_{Δz′}=F⁻¹{F{Uₙ(x,y)}·H_{Δz′}(fₓ,f_{y})};
Uₙ(x,y)=Λ{Uₙ₋₁(x,y)}_{Δz′}=\sqrt{I(x,y)}·exp[jφ₀]·Mₙ(x,y)+ASM{Uₙ₋₁(x,y)}_{Δz′}·[1−Mₙ(x,y)];
wherein ASM{·}_{Δz′} represents a calculation formula of the angular spectrum method for diffraction, Δz′ represents the optimized depth interval, and Uₙ(x, y) represents a complex amplitude of an n-th depth layer; F{·} represents a Fourier transform function, F⁻¹{·} represents an inverse Fourier transform function, and H_{Δz′}(fₓ,f_{y}) represents the optical transfer function; Λ{·} represents angular spectrum diffraction processing, and Uₙ₋₁(x, y) represents a complex amplitude of an (n−1)-th depth layer; \sqrt{I(x,y)} represents an amplitude of an intensity image; j represents an imaginary unit; φ₀ represents a constant phase term; Mₙ(x,y) represents a Boolean mask corresponding to the n-th depth layer, n∈[0, N−1], and N is a total number of depth layers in the diffraction simulation.

12. A computer device, comprising a memory, a processor, and a computer program stored in the memory and executable on the processor, wherein the processor executes the computer program to implement the multi-depth diffraction field computing method based on phase initialization according to claim 11.

13. A non-transitory computer-readable storage medium storing a computer program, wherein the computer program, when executed by a processor, implements the multi-depth diffraction field computing method based on phase initialization according to claim 11.

14. The multi-depth diffraction field computing method based on phase initialization according to claim 11, wherein a formula for calculating the complex amplitude of the hologram plane is as follows:
Uₕ(x,y) =ASM{U_{N-1}(x,y)}_{-z}_{ₕ}_{′-(N-1)Δz′};
wherein Uₕ(x,y) represents the complex amplitude of the hologram plane Sₕ, (−zₕ′−(N−1)Δz′) represents a backward distance from an (N−1)-th depth layer to the hologram plane Sₕ, zₕ represents a distance from the first depth layer to the hologram plane Sₕ, and zₕ′ represents a distance after zₕ is optimized.

15. A computer device, comprising a memory, a processor, and a computer program stored in the memory and executable on the processor, wherein the processor executes the computer program to implement the multi-depth diffraction field computing method based on phase initialization according to claim 14.

16. A non-transitory computer-readable storage medium storing a computer program, wherein the computer program, when executed by a processor, implements the multi-depth diffraction field computing method based on phase initialization according to claim 14.

17. A computer device, comprising a memory, a processor, and a computer program stored in the memory and executable on the processor, wherein the processor executes the computer program to implement the multi-depth diffraction field computing method based on phase initialization according to claim 1.

18. A non-transitory computer-readable storage medium storing a computer program, wherein the computer program, when executed by a processor, implements the multi-depth diffraction field computing method based on phase initialization according to claim 1.
